(19) United States
(12) Patent Application Publication
(10) Pub. No.: US 2013/0278622 A1
(43) Pub. Date: Oct. 24, 2013

(54) Secure and Authenticated Transactions with Mobile Devices

(71) Applicant: NETSPECTRUM INC., Sant Clara, CA (US)

(72) Inventors: Jun Sun, Fremont, CA (US); Dong Zhou, San Jose, CA (US)

(73) Assignee: Netspectrum Inc., Sant Clara, CA (US)

(21) Appl. No.: 13/868,844

(22) Filed: Apr. 23, 2013

Related U.S. Application Data
(60) Provisional application No. 61/637,201, filed on Apr. 23, 2012.
(60) Provisional application No. 61/703,380, filed on Sep. 20, 2012.

(51) Int. Cl. G06Q 20/22; G06T 11/00

(52) U.S. Cl. CPC G06Q 20/22; G06F 8/61; G06T 11/001
USPC 345/589; 717/178; 705/44

(57) ABSTRACT

Embodiments of the invention include a platform for using 2D barcodes to establish secure authenticated communication between two computing devices that are in proximity to each other. A two-tier application architecture using a single base app and dynamic add-on applets is used. 2D barcodes can be distinctively visually branded. According to other aspects, the security of mobile payment systems are enhanced by (1) a triangular payment settlement in which the sender and receiver of payment each submit transaction information independently to the same payment server; (2) sensitive information is split into two parts, one of which is stored on a mobile device, and the other of which is stored on a payment server, and the two parts are only combined and exist transiently in the payment server's volatile memory when executing a transaction; and (3) a process to securely update profile pictures associated with payment accounts.

### CROSS-REFERENCE TO RELATED APPLICATIONS

This application claims the benefit of U.S. Provisional Application No. 61/637,201 filed Apr. 23, 2012, and U.S. Provisional Application No. 61/703,380 filed Sep. 20, 2012, the contents of which are incorporated by reference herein in their entirety.

### BACKGROUND

1. Technical Field

This invention relates to secure and authenticated transactions with mobile devices.

2. Description of Related Art

Traditional Internet applications designed to be executed on personal computers do not take advantage of geo-location or proximity of other computers in performing tasks. This may be considered a natural consequence of the fact that the bulk and heft of traditional personal computers prevented them from being easily moved from place to place. Now that small, light computing devices such as smartphones have become commonplace, computing devices are now commonly carried from place to place: they are truly mobile computing devices. Yet, the legacy of stationary computers has influenced how mobile computing devices operate. Many mobile applications today still use PC/Internet style to perform certain actions, even when two phones are in proximity. For example, the dominant way of sharing a picture from a mobile phone to another nearby mobile phone is through emailing the picture, where the user would either have to type in the email address or find it in the contact book. This use scenario does not take the proximity factor into consideration and is very similar to PC/Internet type of applications.

Compared with PC/Internet applications, mobile applications are very demanding in user experience. Keyboard input is considered one of the worst user interface (“UI”) experiences on mobile devices and could kill an otherwise successful mobile application.

In recent years, a few technologies were invented to take advantages of rich set of sensors on Smartphones that are typically not present on PCs and take proximity into consideration to improve UI experience. We call this set of applications proximity-based mobile applications.

All technologies for mobile proximity-based applications center around two fundamental aspects:
1. How two devices detect and discover each other.
2. How they communication to each other.
   The following examples of peer-to-peer communication in proximity each have significant drawbacks. These drawbacks have prevented their widespread adoption in the field of mobile applications.

### Near Field Communication (NFC)

Many newer smartphones embed a small chip, called an NFC chip, into the phone or into the SIM card. When two such devices are close together, typically less than 10 cm apart, they sense each other and start to communicate with a bandwidth up to ˜400 Kb/s.

Since NFC needs a new chip inside the phone or SIM card, it has several negative impacts on its adoptions and applications:
1. Longer adoption curve and higher cost associated with the chip and availability of the chip on a handset chipset.
2. Limitations of driver and API exported by OS. Not all features are available to generic applications.
3. Lack of inter-operability among different operating systems.

### Bump

Bump Technology (http://bu.mp) supports pairing up two phones that bump into each other at the same time and same location and lets them communicate with each other. In implementation, the two phones send bumping characteristics, such as time, location, accelerometer data, etc, to an Internet server. The server will decide whether two phones are bumping into each other or not based on a set of heuristics. If such a pairing is determined, a relay channel is established between them.

Currently this technology has a few drawbacks:
1. Pairing is not precise, that is, false positives in pairing are possible, and miss pairing can happen. This is because location, time and accelerometer data are imprecise and matched based on proximate heuristics. Two phones bumping roughly at the same place and roughly at the same time can be paired together, even though they are not bumping into each other. This can be a security concern for high-valued applications such as payment transactions.
2. Pairing is not reliable, that is, false negative rate is high. Because of the need to raise precision, some borderline bump actions are rejected, often resulting in repeated trials for a successful bump pairing.

### Sonic or Ultrasonic as Communication Channels

We have seen a few companies (e.g., Tagtile, SparkBase) that are now using the microphone and speaker(s) on the phones to communicate digital information with its environment. Specifically, digital information is transmitted in sonic or ultrasonic waves, and is then captured by microphone and decoded.

This technology is not reliable for at least the following reasons:
1. Phones today generally cannot generate ultrasonic waves. If ultrasonic is used, phones can only receive the information from an external device.
2. This technology can suffer from variations of sound hardware design and processing in different smartphones, which can lead to signals not being accurately sent and/or properly interpreted.

### AllJoyn

Qualcomm invented and later open-sourced its AllJoyn technology for mobile devices to communicate spontaneously when they are in proximity. They use Wi-Fi and Bluetooth to discover peers in neighborhood and discover each other using a set of network protocols.

The main drawback of this approach is that discovery based on such radio technologies is random and opportunistic, rather than based on user's intention. This discourages many useful scenarios such as payment.

Smartphone based mobile payment systems are maturing, but today's mobile payment systems are still not secure enough for widespread adoption. Specifically, in typical payment systems, the receiver of the payment contacts a payment server. The receiver convinces the payment server that the transaction is legitimate by obtaining a secret value (such as the sender's card number) and transmits it to the payment server. This approach leaves the system vulnerable to attacks by hackers that illegally obtain sensitive payment information and then forge communications between the receiver and the payment server.

In addition to the challenges of security for mobile applications, app developers face great challenges in promoting their apps. Today with more than half million applications in iTunes app store and almost equal number of apps in the Android Market, a new app is hardly noticeable or even searchable by users. When marketing barriers increase, mobile apps, including proximity-based apps, with less compelling use cases are falling below the critical mass of users to get even started. A good example is loyalty programs for small and medium sized businesses (“SMB”). While such an app is useful, it tends to be prohibitively expensive for SMB owners to develop, promote and maintain their own mobile apps for their customers. Additionally, a recent study shows the total numbers of applications installed on iPhone and Android are reaching high tens. With this many apps on the phone, users often forget about the apps they have. Further, for each execution of a mobile app, a user would have to do many more finger swipes and clicks or otherwise take more time to search for the app to launch. A user that participates in 10 different loyalty programs from 10 different stores may need to have 10 different apps cluttering the user's device. For every additional app that a user downloads, it increases the burden on the user to select and execute the proper app at the appropriate time.

### SUMMARY

To address the challenges highlighted above, embodiments of the invention include a platform for using 2D barcodes to establish secure authenticated communication between two computing devices that are in proximity to each other. According to one aspect of the invention, when two computing devices are in proximity, one of them, referred to herein as a displayer, encodes some essential information into a 2D barcode and displays it on a screen. The other device, referred to herein as a scanner, uses optical sensor(s) to scan the image and decode the information. With the decoded information, the scanner can communicate with the displayer via a TCP/IP channel. This communication channel can be secure so that no third party can intercept the message. This communication channel can also be authenticated in the sense that the scanner is assured to be talking to the device that displayed the barcode, and the displayer is assured to be talking to the device that did the scanning.

Advantages of embodiments of the platform for using 2D barcodes to establish secure authenticated communication between two computing devices in proximity include:
1. All smartphones have a graphic display screen and almost all of them have a camera. It can be widely adopted today and is platform-agnostic from the beginning.
2. 2D barcode encodes precise information. The chance of false positives or false negatives occurring is extremely remote.
3. Scanning is quick, typically taking around 0.5 second once the code is in the capture zone.
4. Displaying and scanning provide proof of user intention. The displaying and scanning of a barcode cannot accidentally happen. Thus any transaction carries certain proof of a user's intention.
5. Evidence of proximity. Capturing a displayed barcode provides evidence that the scanner is in proximity to the displayer.

Scanning a 2D barcode dictates that information only flows in one-direction (i.e., from displayer to scanner) and the amount to the information encoded in the 2D barcode is limited. Embodiments of the platform compensate for these limitations by letting both devices communicate over other communication channels such as Wi-Fi, Bluetooth, and 3G/4G networks for the major part of communication. 2D barcode scanning serves as a trigger for subsequent communications and as a seed of later security and authentication.

While in this disclosure, for ease of explanation, we use 2D barcode to convey digital information between displayer device and scanner device, we are not limited to 2D barcode. In practice, our invention applies to any visual pattern that encodes digital information and can be precisely decoded via an optical sensor on the scanner device.

According to another aspect of the invention, to address the challenges of app discovery and promotion described above, a two-tier application architecture using a single base app and dynamic add-on applets is used:
User installs a base mobile application, called the base app.
Each use case, such as loyalty program or payment option for a store, has a corresponding applet with its own UI, persistent data, etc., running on top of the base app.
Each time user uses the base app to scan a barcode, the base app would check to see if the corresponding applet is already installed. If so, it is invoked and run. Otherwise the base app would go to the Internet and automatically download, install and initialize the applet (in some cases after obtaining user permission to proceed).

The two-tier application architecture is advantageous to both users and developers. During this process, the user would have never needed to perform an explicit search or discovery of the new applet, and would have minimal UI interactions with the mobile device. The barcode scanned in proximity serves as the seed info to trigger automatic search, download and installation, and serves as a UI shortcut for otherwise lengthy, cumbersome user interaction steps including keyboard inputs. For application developers, after developing the applet, they need not spend resources promoting the applet separately from the base app, because the applet would be discovered and installed automatically after scanning the application-targeted barcodes. The developers can concentrate instead on promoting the barcode associated with the applet.

According to another aspect of the invention, 2D barcodes pertaining to the single base app of the two-layer application architecture described above can be distinctively visually branded to indicate to the user to use the single base app to scan the barcode. Further, information can be encoded in the barcode in a standard format such that when user does not have the base app installed or when user does not use the base app to scan the branded barcode, user will still have a fluid experience that leads to the installation or execution of the base app and further leads to the installation and execution of the intended applet. Together with the two-layer application architecture, this technique reduces the number of finger swipes and the amount of search time for running desired applets.

According to another aspect of the invention, the security of mobile payment systems is enhanced by a triangular payment settlement. In such a triangular payment settlement, the sender side and the receiver side of a payment negotiate a payment transaction and each submits transaction information independently to the same payment server.

According to another aspect of the invention, the security of mobile payment systems is enhanced by a split management of secrecy. In such a system, sensitive information is split into two parts, one of which is stored on a mobile device, and the other of which is stored on a payment server. The two parts are only combined and exist transiently in the payment server's volatile memory when executing a transaction.

According to another aspect of the invention, the security of mobile payment systems is enhanced by a process to securely update profile pictures. A user's new profile picture associated with a payment system goes through a maturing period before it completely replaces an original mature picture. Such a security feature decreases the possibility of fraud.

### BRIEF DESCRIPTION OF THE DRAWINGS

FIG. 1 illustrates system components in accordance with an embodiment.

FIG. 2 is a block diagram illustrating the logical composition of information in a barcode in accordance with an embodiment.

FIG. 3 is an interaction diagram illustrating a basic mode of operation in accordance with an embodiment.

FIG. 4 is an interaction diagram illustrating a direct secure authenticated communication without a communication router, in accordance with an embodiment.

FIG. 5 is a block diagram illustrating a base form application level architecture in accordance with an embodiment.

FIG. 6 is a block diagram illustrating a peer-to-peer application level architecture in accordance with an embodiment.

FIG. 7 is a flowchart illustrating execution of a bass app and add-on applet in accordance with an embodiment.

FIG. 8 is an example of a prior art QR code without visual branding.

FIG. 9 is an example of a QR code visually branded with a logo in accordance with an embodiment.

FIG. 10 is an example of a QR code visually branded with color in accordance with an embodiment.

FIG. 11 is an example of a QR code visually branded using shape in surrounding area in accordance with an embodiment.

FIG. 12 is an illustration of a mobile payment system using 2D barcodes, in accordance with an embodiment.

FIG. 13 is an illustration of a mobile payment system, in accordance with an embodiment.

FIG. 14 is an illustration of four steps of a payment transaction, in accordance with an embodiment.

FIG. 15 is a flowchart illustrating a method of using split-stored sensitive data in a payment transaction, in accordance with an embodiment.

FIG. 16A is an illustration of an example user interface of a mobile device including an immature profile picture in accordance with an embodiment.

FIG. 16B is an illustration of an example user interface of a mobile device including a mature profile picture in accordance with an embodiment.

FIG. 16C is an illustration of another example user interface of a mobile device including both a mature old and an immature new profile picture in accordance with an embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### 1. Communication Level System Diagrams and Processing Flow

### 1.1 Basic System

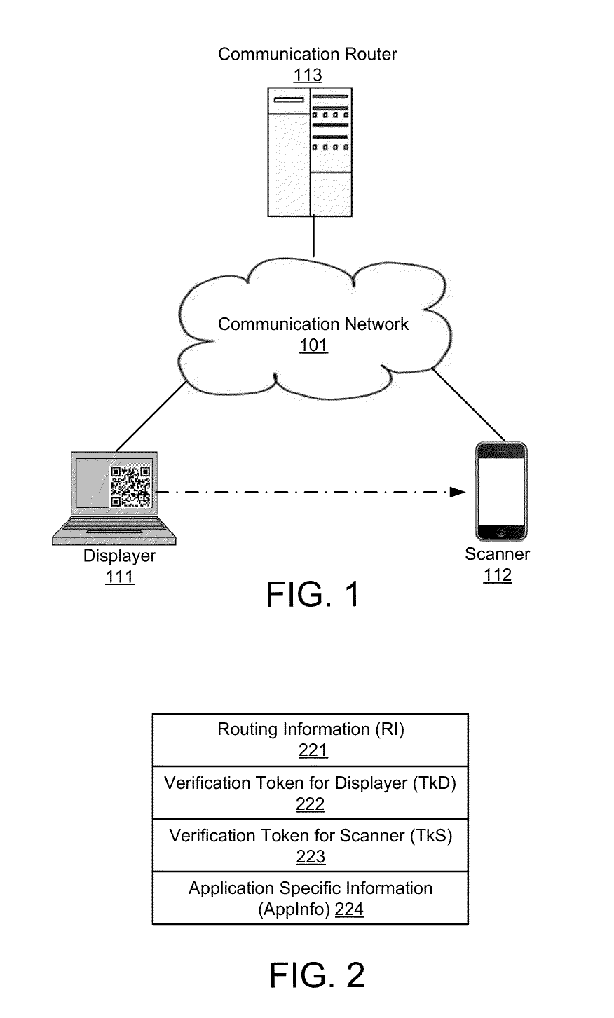

FIG. 1 shows high level components of a system in accordance with an embodiment of the invention. The system includes a displayer 111, a scanner 112, at least one communication router 113, and a communication network 101.

The displayer 111 is a mobile or stationary computing device, or a computing device with access to a remote display. The displayer 111 has access to the Internet or other communication network 101, and has a screen to display a barcode.

The scanner 112 has a camera that can be used to take picture of the barcode displayed on the screen of the displayer 111. The scanner 112 is typically a mobile phone, but can also be a generic computing device. However, at least one of the displayer 111 and the scanner 112 is a mobile device, such as a smartphone or a tablet computing device, so that the scanner 112 and displayer 111 can be brought within proximity to each other.

The one or more communication routing devices (or routers) 113 are used to set up the communication channel between a displayer 111 and a scanner 112, and may also be used after that to relay information between the two. Address(es) of such routers 113 may be pre-shared between the displayer 111 and the scanner 112, or be communicated as part of the barcode. In some embodiments of the system, various Internet technologies, such as STUN, TURN and ICE, can be used to implement the communication router 113.

The communication network, which can be the Internet, or any other type of network, supports data exchange between a displayer 111, a scanner 112, and one or more communication routers 113.

### 1.2 2D Barcode

FIG. 2 illustrates the logical composition of a 2D barcode in accordance with an embodiment. Note that these data items are logical, some can be combined into a single expression, not all these items are required to be present in a barcode, and if any two or more are present in the same barcode it may be in any order. These logical components include routing information for scanner to reach displayer (RI) 221; security tokens for authenticating displayer (TkD) 222; security tokens for authenticating scanner (TkS) 223; and information specific to applications (AppInfo) 224.

RI 221 is mandatory in order to establish a communication channel between displayer 111 and scanner 112. The simplest case of RI 221 might be an IP address and a port number and port type (TCP/UDP). In some other cases it can be more complicated. The displayers 111 are typically behind some Network Address Translated (NAT) gateway and some form of firewall. It may not be directly accessible from another node in the Internet. In this case, the communication router 113 can serve as a relay server for the scanner 112 to talk to the displayer 111.

TkD 222 is optional information for the scanner 112 to verify the displayer 111. In one straightforward form, a TkD 222 is the public key from a public/private key pair owned by displayer 111, and the scanner 112 verifies the computer that it is communicating with is the computer that it scanned a bar code from by sending a challenge message and later verifying the challenge response with such a public key. TkD 222 can also be used as the initial encryption key when the scanner 112 first initiates the communication with the displayer 111.

TkS 223 is optional information for the displayer 111 to identify and/or verify the scanner 112. The scanner 112 sends the TkS 223 from the barcode back to the displayer 111 to prove that it has indeed scanned a barcode displayed by the displayer 111.

AppInfo 224 is an optional application-specific parameter passed from displayer 111 to scanner 112 during the scanning phase. Typically the scanner side can pass it, or the processing result of it, back to the displayer side after the communication channel is established. For example, in the payment application, this AppInfo 224 can carry invoice number so that the payment software on the displayer side can quickly find the transaction without maintaining a separate mapping table that associates TkS 223 with a transaction as identified by the invoice number.

In one embodiment, among RI 221, TkD 222, TkS 223, and AppInfo 224, only RI 221 is required to be included in the barcoded information. Others are optional, depending on the particular application.

When TkS 223 is present, it must be directly encoded into 2D barcode in order to authenticate the scanner 112. Other factors can be obtained through a 3rd party server. In some embodiments, it is beneficial to obtain factors through a 3^{rd} party server because the 2D barcode has limited capacity for encoding information, and there may not be enough space to encode all of the above mentioned information directly in the 2D barcode.

In various embodiments, some of the coding for the factors can be combined. For example, a dynamically generated public key for each session can serve both the purpose for TkD 222 and TkS 223, as well as AppInfo 224. The dynamically generated public key can serve as TkD 222 as it can be used to encode data and challenges to authenticate the displayer 111; the same key can serve as TkS 223 because it is created dynamically and has extremely low chance of collision, making it possible to identify and authenticate the scanner 112. Secondly, when RI 221, TkD 222, and AppInfo 224 are all indirectly obtained, the same ID can be used to represent these three different data items.

### 1.3 Basic Processing Flows

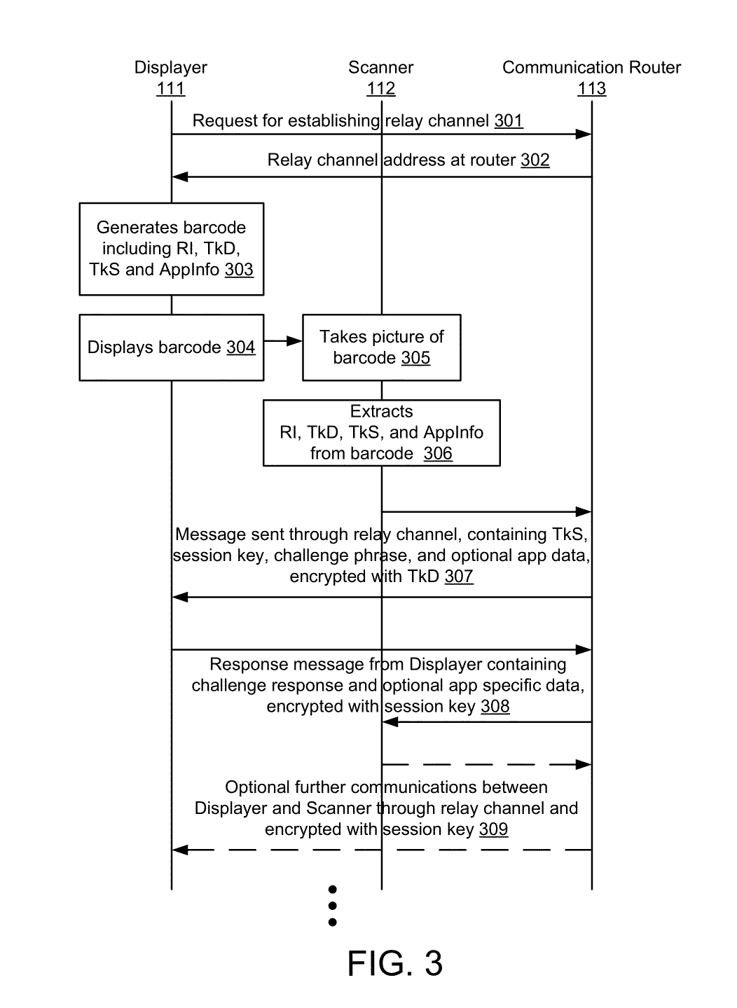

FIG. 3 is an interaction diagram illustrating a basic mode of operation in accordance with an embodiment. In this embodiment, the barcode contains all four parts of information: RI 221, TkD 222, TkS 223, and AppInfo 224. A communication router 113 is used for a scanner 112 to reach a displayer 111. The displayer 111 and the scanner 112 communicate through a relay channel of the router 113.

In step 301, the displayer 111 requests a relay channel to be established at the router 113. In step 302, the router 113 sends the established relay channel info (IP address and port number) back to the displayer 111. In this example, in step 303, the displayer 111 generates a barcode using the relay channel information as the RI 221, the public key from a public/private key pair as the TkD 222, randomly generated number as TkS 223, and some application specific information as AppInfo 224.

In step 304, the displayer 111 displays the generated barcode on its screen. In step 305, the scanner 112 takes picture of the barcode. In step 306, in this example, the scanner 112 extracts RI 221, TkD 222, TkS 223, and AppInfo 224 from the barcode.

In step 307, using relay channel info contained in RI 221, the scanner 112 sends a message to the displayer 111 through the relay of the router 113. In various embodiments, the message may be encrypted using the TkD 222 as the encryption key, and the message includes TkS 223, a session key to encrypt future communications, a challenge (such as a nonce) to the displayer, and AppInfo 224 or information derived from AppInfo 224.

The displayer 111 uses its private key to decode the received message, and extracts information from the message. It checks to see if TkS 223 is the expected one. If not, the displayer 111 drops the communication. Otherwise, in step 308, the displayer 111 uses its private key to generate a response to the challenge. Lastly it encrypts the response message with the session key and sends back to the scanner 112 via the communication router's 113 relay channel.

The scanner 112 receives the message and uses the session key to decrypt the message. It further uses TkD 222 to decrypt the challenge response generated by the displayer and verifies its correctness. If it is not the same one as was generated in the previous step, the scanner 112 drops the communication. Otherwise and optionally, in step 309, more messages are exchanged between the displayer 111 and the scanner 112, through the relay of the router 113, for application specific purposes. Such messages are also encrypted with the session key established in the steps above.

### 1.4 Variations from Base Form

Components and mode of operation of embodiments of the invention can vary via several dimensions. Each variation in each dimension can in general be combined with another variation in another dimension. The following section enumerates the variation dimensions.

### Variations in Routing

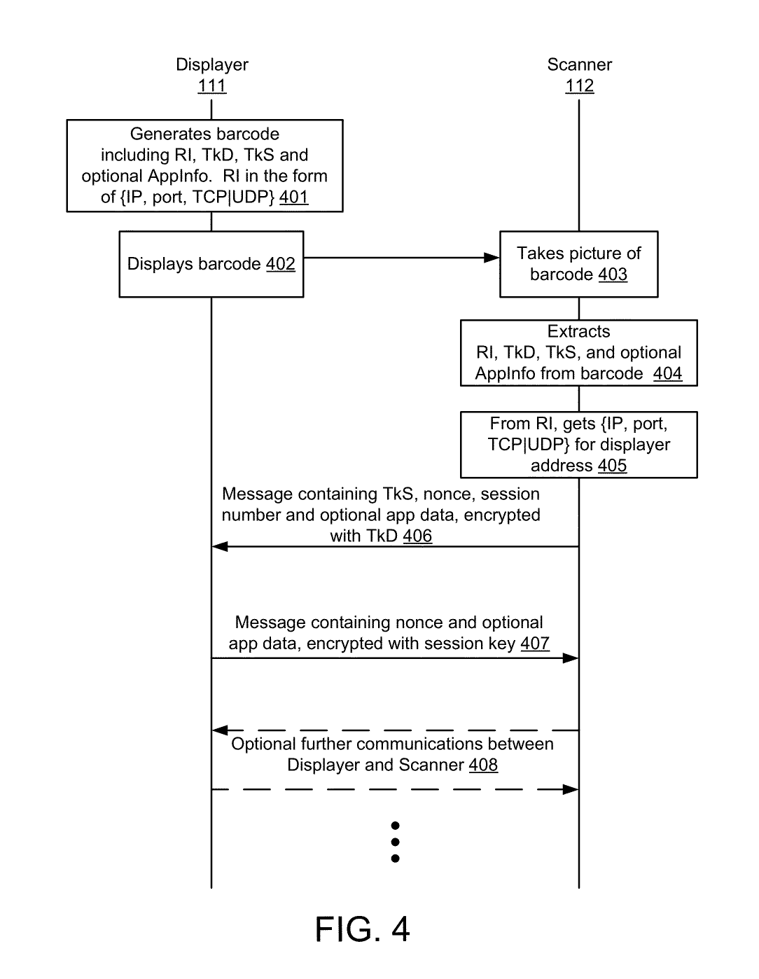

As discussed in basic processing flow, the displayer 111 and the scanner 112 can communicate using a relay channel through the relay of the router 113, and the RI 221 in the barcode is the address of the relay channel. The displayer 111 and the scanner 112 can also directly communicate without the need of a router 113. For example: the displayer 111 has a full Internet IP address, and RI 221 can logically be {IP, port, TCP|UDP}. In another example, the RI 221 can be a URL such as http://www.flashme.com, and the displayer 111 and the scanner 112 communicate as a Web server and a Web client. FIG. 4 shows the flow diagram of using a full Internet IP address to establish secure and authenticated communication channel between a displayer 111 and a scanner 112 without a router 113.

In step 401, the displayer 111 generates a barcode encoding RI 221, TkD 222, TkS 223, and optional AppInfo 224, where RI 221 is in the form of {IP, port, TCP|UDP}. In step 402, the displayer 111 displays the barcode on its screen.

In step 403, the scanner 112 takes picture of the displayed barcode, and in step 404 extracts RI 221, TkD 222, TkS 223, and optional AppInfo 224. In step 405, the scanner 112 gets the displayer's full Internet address from RI 221 in the form of {IP, port, TCP|UDP}.

In step 406, the scanner 112 sends a message to the displayer 111. The message contains TkS 223, a session key, a nonce or other challenge to the displayer, and optional application data, and encrypted with TkD 222. In step 407, the displayer 111 sends back a message containing the nonce (or other response to the challenge) and optional new application data, and encrypted with session key. In step 408, the scanner 112 and the displayer 111 optionally exchange more messages encrypted with the session key.

In the third possibility, the displayer 111 and scanner 112 can communicate with each other directly with the assistance of a communication router 113. Well-known technologies such as STUN/TURN/ICE and SIP/SDP can be used to assist the routing. Depending on the technology used, the RI 221 can be in different formats. For example, if SIP is used, the routing info can be a SIP URL such as sip:user@sip_proxy_server.com.

Independent of how the displayer 111 communicates with the scanner 112, the RI 221 can be directly displayed in the barcode or indirectly obtained through a known server. In the latter case, the displayer 111 registers its RI 221 with a known server identified by its ID. The ID is encoded in the 2D barcode in place of RI 221. The scanner 112 obtains the ID and queries the known server for detailed routing information.

Yet another approach of setting up a communication channel is the push approach, where the displayer 111 first registers its notification address (such as a SMS number) with the router 113. Later when the scanner 112 requests to communicate with displayer 111, the router 113 sends a push notification to the displayer 111 to communicate with the scanner 112.

### Variations in TkD

As discussed above, the presence of the TkD 222 in the barcode is optional. FIG. 3 illustrates an example where TkD 222 is present. There are cases where TkD 222 is not necessary because the scanner 112 does not need to verify the displayer 111. For example, a picture sharing application may not need to verify the displayer 111.

While FIG. 3 illustrates an example where TkD 222 was directly encoded in the barcode, it can also be indirectly obtained. For example, the displayer 111 registers its TkD 222 with a known server identified by its ID. The ID is displayed in the 2D barcode in place of TkD 222. The scanner 112 obtains the ID and queries the known server for TkD 222.

### Variations in TkS

As discussed above, the presence of TkS 223 in the barcode is optional. FIG. 3 illustrates an example when TkS 223 is present. There are cases where TkS is not necessary. For example, in a TV shopping scenario, the displayer 111 may not need to verify the scanner 112 is indeed scanning a live TV show.

In one embodiment, TkS 223 can be strengthened with an additional reverse scan. In this case, after the scanner 112 scans the barcode displayed on the screen of the displayer 111, the scanner 112 generates a 2D barcode and displays it for the displayer 111 to scan. Among other optional info is TkS′, a token that can be used by the displayer 111 to verify the scanner 112 during the communication phase. A straightforward implementation of TkS′ is the public key from a public/private key pair owned by the scanner 112. This scenario has stronger security than the single scan case because in the single scanning case, a remote intruder can spoof a barcode image and then pretend to be the scanner 112 and start to talk to the displayer 111. With dual scanning, this risk is virtually eliminated.

### Variations in AppInfo

The presence of AppInfo 224 in the barcode is optional. Further, when it is present, AppInfo 224 can be directly encoded into barcode, or be indirectly obtained from a well-known server through an ID from the barcode.

### 2. Two-Tier Architecture: Single Base App and Dynamic Add-On Applets

### 2.1 The Basic Form

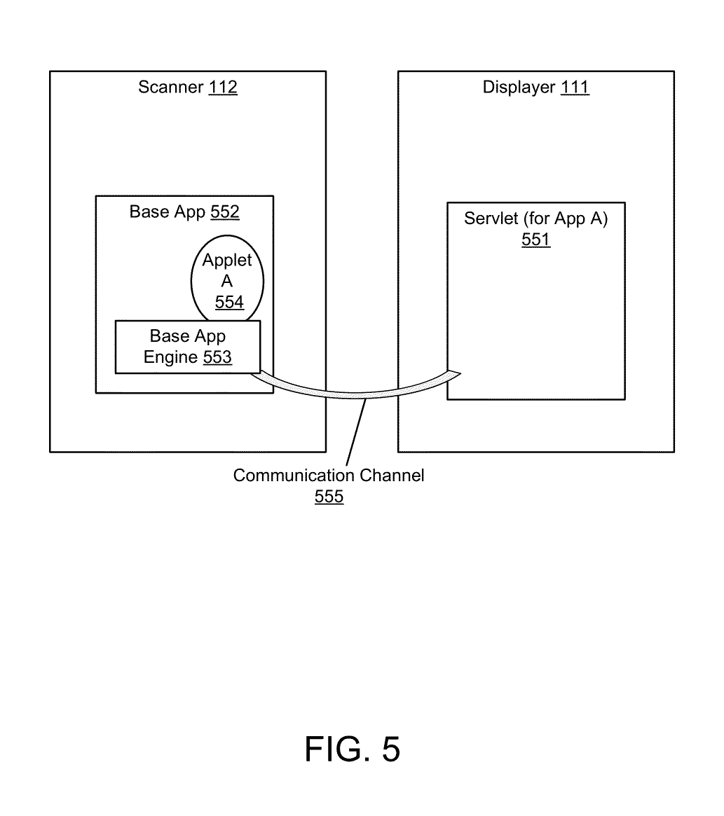

An application layer is built on top of the barcode scanning based spontaneous communication layer described in the previous section. FIG. 5 Error! Reference source not found. illustrates an example basic form of application layer architecture between a displayer 111 and a scanner 112 with a communication channel 555 between them. At the application layer, architecture includes a base app 552 with a base app engine 553, an add-on applet 554, and a servlet 551.

The base app 552 is a single mobile application installed on computing devices such as scanners 112. In one embodiment, the base app 552 is installed as a native application, which then allows different add-on applets 554 to run on top of the base app engine 553 to perform various functions. The base app 552 provides add-on applets 554 an execution environment including, depending on the user's privacy settings or other preferences, at least one or more of the following: access to generic resources on devices such as file storage and Internet access; a secure and authenticated channel triggered by barcode scanning to communicate with the servlet 551 associated with the add-on applet; access to user's personal data and identity info; and access to user's sensitive information, including credit card data, as well as information related to user's various other cards (such as loyalty reward cards).

The add-on applet 554 is a piece of code that runs on top of base app 552 and provides logic and UI for a specific application, e.g., payment and content sharing. The add-on applet 554 can be in two forms: either natively integrated with the base app 552 or dynamically downloaded from the Internet to run on the base app engine 553, e.g., as a HTML/JavaScript based web app.

The servlet 551 is a piece of software, for example on the displayer 111, that communicates with the base app 552 and add-on applet 554 to carry out a specific application, e.g., payment. The servlet 551 is typically within the displayer 111, while the base app 552 and add-on applets 554 are typically within the scanner 112, although in some cases the roles may be reversed. For ease of description, this description will assume throughout that the servlet 551 is within the displayer 111 and the base app 552 is within the scanner 112.

### 2.2 Peer-To-Peer Form

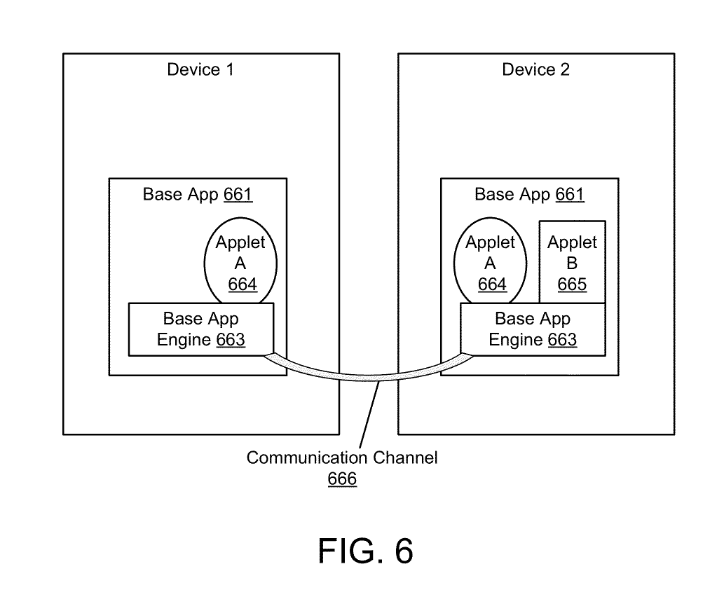

Certain add-on applets can serve the same function as a servlet. This is called peer-to-peer form, as illustrated in FIG. 6. In this example, device 1 and device 2 communicate through communication channel 666. Both device 1 and device 2 have a base app 661 installed, including a base app engine 663, and both devices have add-on applet A 664 running on top of the base app 661. The devices 1 and 2 may have various other add-on applets, respectively, illustrated by the presence of add-on applet B 665 on device 2 in FIG. 6. Example applications that use the peer-to-peer form illustrated in FIG. 6 include peer-to-peer content sharing and peer-to-peer payment.

### 2.3 Execution Flow with Applets

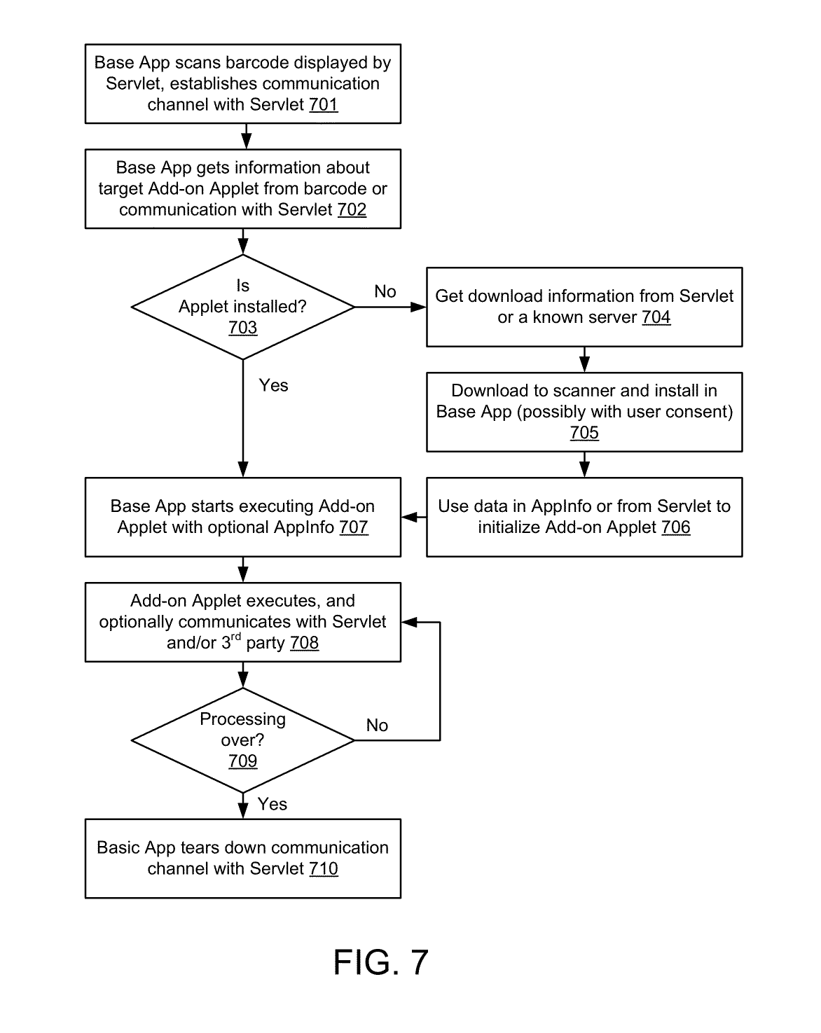

A transaction of a particular application starts with the servlet 551 performing application specific UI/processing and generating and displaying a barcode. The execution flow on the scanner side is illustrated by the processing flow in FIG. 7. In step 701, when the base app 552 of the scanner 112 scans the barcode, a communication channel 555 is established between the base app 552 and the servlet 551 using the protocols and processing steps described above. In step 702, information describing the applet 554 for the current application is either contained in the barcode or is transferred from the servlet 551 to the base app 552.

In step 703, the base app 552 determines whether the applet 554 is installed. If the applet 554 is installed, the processing proceeds to step 707. If the applet 554 is not installed, in step 704, information about how to download the right version of the applet is either obtained from the servlet 551, or an outside known server. In step 705, the applet 554 is then downloaded to the scanner 112 and installed in the base app 552 (possibly with user consent). In step 706, optional information contained in the barcode or exchanged through the communication channel 555 is then used to initialize the applet 554 so that the execution flow can proceed to step 707.

In step 707, the base app 552 then starts to execute the applet 554 and passes the optional AppInfo 224 to it. In step 708, the applet 554 will continue the communication with the servlet 551, including passing processing results of AppInfo 224 back to the servlet 551 if so designed. During this process, the applet 554 and the servlet 551 may contact other application-specific server(s). For example, in the case of mobile payment, both will contact a payment server to transfer money between respective accounts. These interactions will be described in greater detail in sections below. The applet 554 continues to execute until it is determined in step 709 that the processing is complete. Then, in step 710, the communication channel will be torn down, for example by the basic app 552.

Note that, while the above description assumes an applet 554 communicating with a servlet 551, the execution flow between two peer applets 664 is similar as will be understood by one of ordinary skill in the art in view of the description above.

The two-tiered approach, with single base app 552 and a number of add-on applets 554 within it, and the ability for the base app 552 to use the information contained in barcode to automatically identify and execute the applet 554, and automatically download, install and initialize the applet 554 when necessary, considerably reduce the burdens for the user: the burden to recognize the right app from dozens of installed apps, the burden to search/discover, download, install and configure the app, and the burden of swipes and clicks to start the app. The automatic recognition, download and installation, also reduces the amount of resources required on the developers to promote the application.

### 3. Visually Branded 2D Barcode with Assistive Encoding Scheme

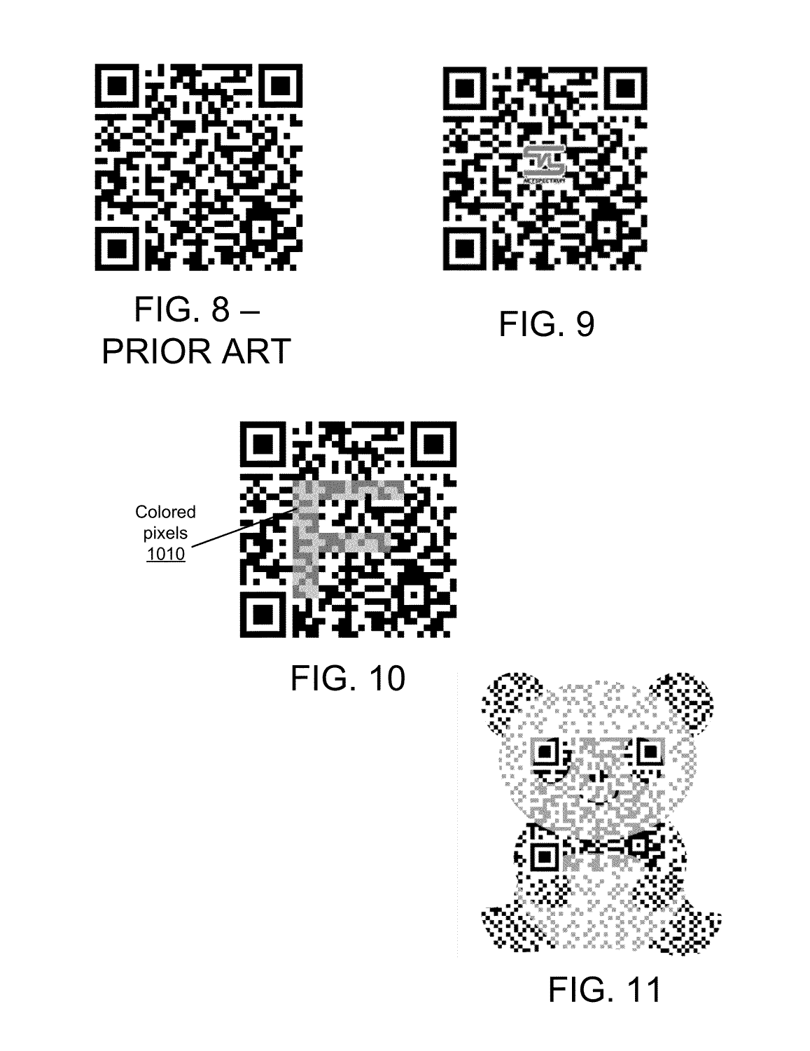

All barcodes are visual patterns that represent digital information (bits). FIG. 8 shows an example of a conventional QR code. According to aspects of the present invention, 2D barcodes are visually distinctively branded to promote the use of a unified platform for proximity-based mobile applications.

There are three ways to visually brand a QR code:
1. QR codes have certain capabilities of error corrections. It can correctly restore the information even if part of the image is distorted. As a consequence, certain desired images can be injected into the QR code. As long as the distorted area is less than the maximum distorted area the QR code can correct, a scanner can still correctly obtain the information. QR code has 4 levels of error corrections. Each level can tolerate different percent of corruption areas, as will be appreciated by those of skill in the art in view of this disclosure. FIG. 9 shows the same barcode in FIG. 8 can be branded with a logo image in the middle (corrupted area) while still preserving the same information.
2. QR codes by default use black dots over white background. However, it is possible to choose different colors for the dots instead, and the colored dots can form a distinctive visual pattern. FIG. 10 shows the same barcode in FIG. 8 can be branded with various color patterns while still preserving the same information.
3. The area surrounding a QR code can be used for visual branding purpose without affecting the ability of the code to be scanned. The simplest way of utilizing the surrounding area for branding is to use text labeling. Other ways involve building a shape around the barcode area. FIG. 11 shows an example of the same barcode in FIG. 8 that is visually branded using the surrounding area.
   These three techniques can be combined together in all possibilities to create a visually branded barcode. Regardless of the visual branding technique employed, the QR code can still encode alphanumeric strings which are in standard URI format, such as http://www.flashme.com or tel:+18005551212. From the visually branded QR code, a scanner 112 can obtain such URI and perform proper actions such as launching a web browser or making a phone call.

According to embodiments of the present invention, barcodes are distinctively visually branded to indicate to a user that they are part of an integrated platform for using 2D barcodes to enable secure authenticated communication between computing devices in proximity to one another. It indicates to a user that only a particular app can fully understand the digital information and perform proper actions. For example, a barcode may encode proprietary routing information to inform the scanner 112 how to reach the displayer 111.

However, not every user will have the appropriate app installed or know ahead of time that he/she has to use a particular app to scan such barcode in order to take full advantage of the platform. Thus, the following scheme can help to achieve a satisfying user experience when a user uses another app to scan a barcode associated with the platform described herein. Conforming to the standard for encoding a URL, the data format has two parts:
1. a standard URL that points a valid WWW server, e.g., http://flashme.com
2. a HTML parameter that encodes specific information, e.g., ?p=d131dd02c5e6eec4693d9a0698aff95c. Note that parameter could also be encoded as URL path, e.g., /p/d131dd02c5e6eec4693d9a0698aff95c.

The following three cases illustrate the various scenarios:
1. User installed base application and uses base application to scan barcode. The base application will decode the proprietary information directly from the barcode and perform necessary actions.
2. User installed base application but uses another scanner app to scan the barcode. The scanner app will typically launch a web browser and open the URL (e.g., http://flashme.com/p/d131dd02c5e6eec4693d9a0698aff95c). The web server can then launch the base application to handle scanned information by feeding a web page that encodes proper URI-schemed links to start executing the installed base application.
3. User did not install the base application and uses another scanner app to scan the barcode. The scanner app will typically launch a web browser and open the URL, which will, for example, prompt user to install the base application.

### 4. Mobile Payment

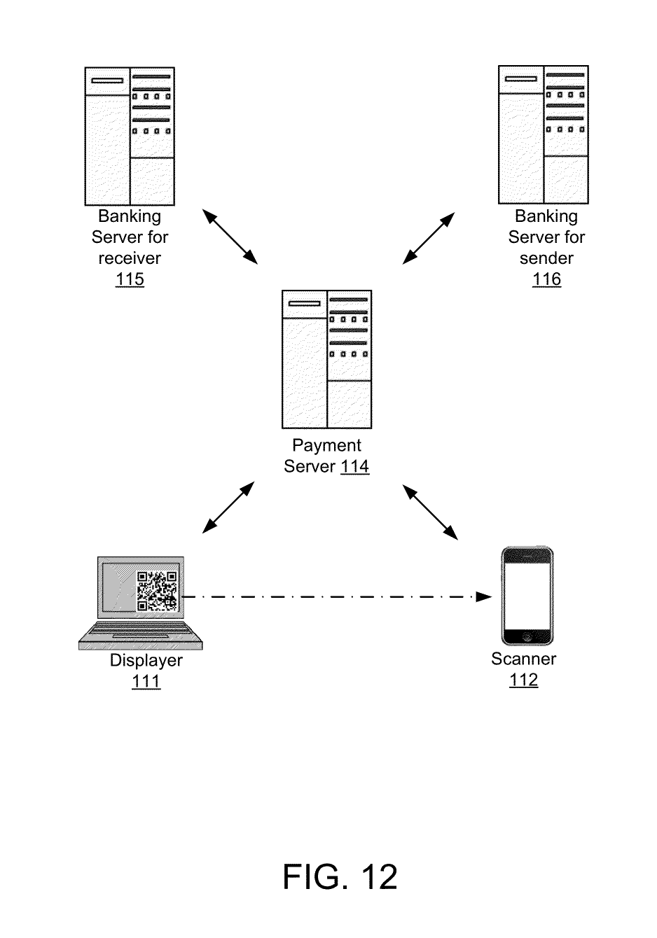

FIG. 12 illustrates a system diagram of mobile payment using 2D barcode triggered secure and authenticated p2p communication and two-tier application architecture. This mobile payment system can be in the basic form (as in FIG. 5) where the displayer is a stationary device, or in the peer-to-peer form (as in FIG. 6) where both parties are mobile devices.

In this diagram, the displayer 111 is requesting money and the scanner 112 is paying the money. The reverse is possible as well. The displayer 111 displays a 2D barcode. The scanner 112 scans the code and connects to the displayer 111 (in some cases via a communication router 113). The displayer 111 and the scanner 112 authenticate with each other based on tokens in the barcode. Optionally, the displayer 111 and the scanner 112 can further authenticate sender's and receiver's identity with a payment server 114. The displayer 111 and the scanner 112 exchange and agree on payment information (sender, receiver, amount and optional description, etc.). The displayer 111 and the scanner 112 mutually generate an encrypted transaction token, which embeds the mutually agreed transaction information. This token cannot be forged by a third party. The displayer 111 and the scanner 112 send the transaction token and their respective private payment information to the payment server 114. For example, payer's private payment info may include credit card number, expiration date, etc. The payment server 114 compares and checks the payment info and transaction token. If the check is successful, the payment server 114 further performs necessary transactions with banking servers 115 and 116 to move the money between proper accounts. Then the payment server 114 sends notification back to the displayer 111 and the scanner 112 on the transaction results.

The above model is different from conventional payment transaction models which typically involve only one party, sender or receiver, to perform the transaction with the server 114. For example, in retail, when a sender (customer) swipes a credit card, the retailer (receiver) contacts the payment server 114 to initiate the transaction. To prove to the payment server 114 that the sender is willing to pay, it typically needs to pass certain secrets from the sender (e.g., credit card number) and is usually followed up by a signature to prove user's permission. As another example, anyone with a PayPal account can send money to another one with a PayPal account via the receiver's email address. In this case, no secrets are disclosed to each other except that the email addresses are exchanged. This model works based on the assumption that nobody is willing to forge a sender in the money transaction (which can be wrong in rare cases). For better user experience, users typically have stored secrets (credit card information or banking information) in the payment server 114 ahead of the transaction, which is risky. If the server 114 is compromised, all sensitive user information are compromised.

According to embodiment of the invention, both parties have to send a non-forgeable mutually agreed transaction token to payment server 114. It makes the system more secure since any counterfeit would require forgery of security token at both parties at the same time. As long as the system can authenticate each of the two devices, it can guarantee transactions are made between a scanner 112 and a displayer 111.

Further, with this model it is possible for payer not to disclose any of its secrets to the receiver. Both parties send its own private payment information separately to payment server 114. Sender might send credit card information and receiver might give its bank account number. These sensitive pieces of information, and even less sensitive information such as email addresses, do not have to be exchanged between sender and receiver.

Another potential advantage is that the payment server does not have to store user's secrets because secrets are sent individually for each transaction. It releases a big security burden for the server side. As a result, the secrets remain in the mobile devices and the respective hands of users.

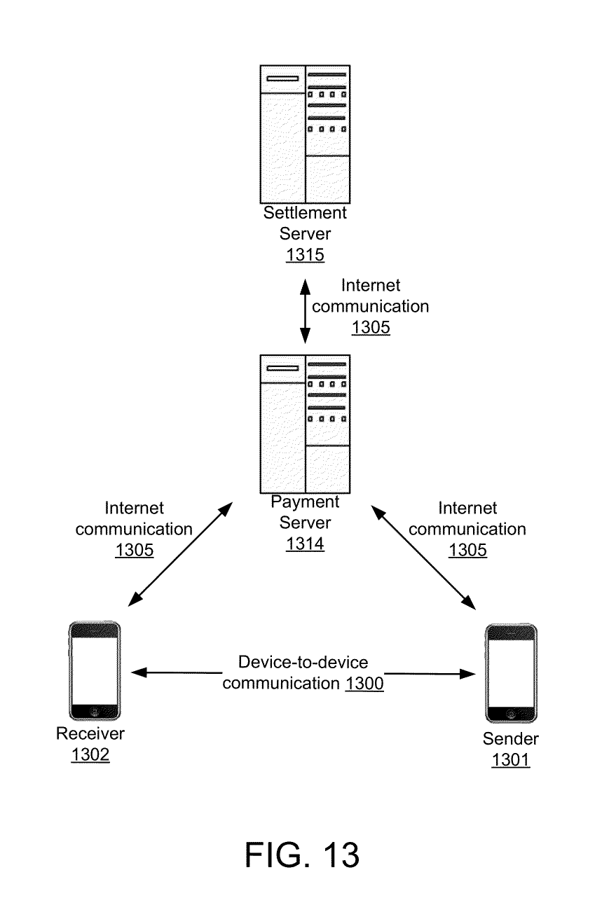

FIG. 13 is an illustration of a mobile payment system, in accordance with another embodiment of the invention. In this example, the mobile payment system includes a sender 1301, a receiver 1302, a payment server 1314, and a settlement server 1315. The sender 1301 and receiver 1302 communicate via device-to-device communication 1300, and the other entities communicate through Internet communication 1305.

The payment server 1314 manages user accounts and money or financial accounts. It communicates with mobile devices, including the sender 1301 and receiver 1302, and decides whether a transaction is allowed. If a transaction is allowed, the payment server 1314 submits necessary information to a settlement server 1315, which may be a conventional type of settlement server in use in conventional payment systems.

### 4.1 Triangular Payment Settlement

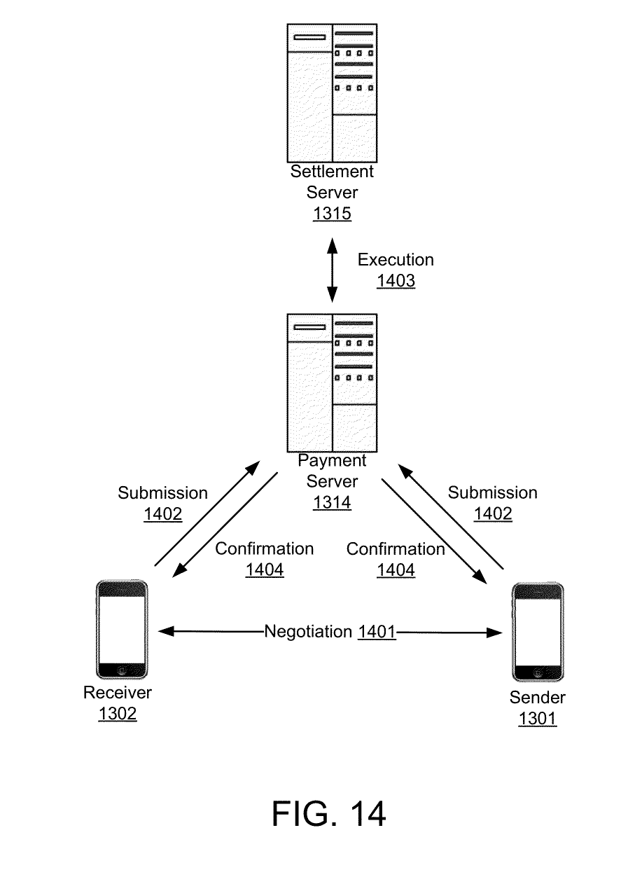

FIG. 14 is an illustration of four steps of a payment transaction among the entities illustrated in FIG. 13, in accordance with an embodiment. This process is referred to as triangular payment settlement. During a negotiation step 1401, the sender 1301 and the receiver 1302 communicate with each other through various possible channels (Bluetooth, WiFi-direct, 2D barcode, IR, audio wave, NFC, Internet) referred to as device-to-device communication 1300. They exchange each other's user information, which in one embodiment includes each other's profile picture, which will be described in greater detail below. At the end of the negotiation step 1401, they agree on final payment information, which includes a system-wide unique invoice identifier, currency and amount.

In step 1402, both the sender 1301 and the receiver 1302 submit a transaction request to the payment server 1314, for example using Internet communication 1305. In addition to user identification and authentication information, the request includes payment information and sensitive account information. Account information is needed so that the server 1314 can decide whether money is drawn from and where money will be sent. It is noted that each user may have multiple accounts of possible different types, such as bank accounts, credit card/debit card accounts, and third party accounts such as a PayPal account.

In step 1403, when the payment server 1314 receives both requests from the sender 1301 and the receiver 1302, it matches them up, performs various security checks, and further submits an execution order to the settlement server 1315 for actual money transfer. A number of different techniques may be used for matching up the requests from senders 1301 and receivers 1302 and for security checks. For example, one implementation is to have sender 1301 and receiver 1302 agree on some non-forgeable shared secret, and then each securely sends such shared secret to the payment server 1314, to be checked by the payment server 1314.

In step 1404, once the execution 1403 is complete, the payment server 1314 relays the transaction status information back to both the sender 1301 and receiver 1302.

According to various embodiments of the invention, the basic payment system described with reference to FIGS. 13 and 14 has enhanced security as compared to conventional payment systems. In contrast to conventional payment systems that only require communication from the receiver 1302 to the server 1314 to execute a transaction, some embodiments of the invention require both the receiver 1302 and the sender 1301 to contact the server with the final payment information. This makes it harder for an attacker to attack through forging transaction messages sent to the server 1314, because the attacker now would need to attempt to forge transaction messages from both the receiver and sender sides of the transaction. In addition, sender 1301 does not have to disclose any secret to the receiver 1302. Rather, it passes sensitive account information directly to the payment server 1314 without going through the receiver 1302, making transactions more secure to the sender 1301.

### 4.2 Split-Stored Sensitive Data

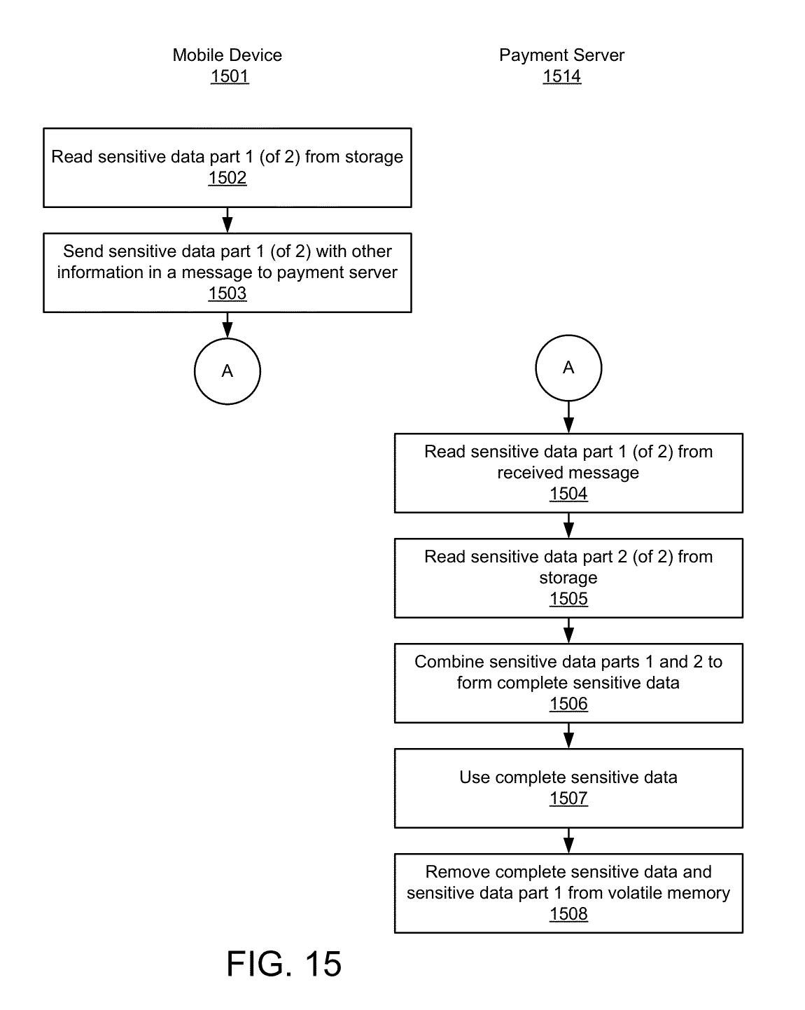

FIG. 15 is a flowchart illustrating a method of using split-stored sensitive data in a payment transaction, in accordance with an embodiment. Split-storage of sensitive data is a second technique that may be used in the payment system illustrated in FIGS. 13-14 to enhance security. A payment system typically involves various sensitive information for authentication, and for paying and receiving money. Such sensitive information, or secrecy, includes account numbers, credit card numbers, expiration dates, etc. Existing payment systems typically store them either on the mobile device or in the Internet cloud. A consequence of this is that such sensitive data is compromised once the device or the server is compromised.

In one embodiment of the invention, sensitive data is split into two parts and stored separately between the mobile device and the payment server. Neither the payment server nor the mobile device keeps a complete copy of the sensitive data. In one implementation, the split of sensitive data happens when an account is bound to the mobile device. A portion of the account number (such as certain digits of a credit card number) is kept locally on the mobile device, and the other portion is securely sent to the payment server 1314 and stored there. For each transaction, the mobile device sends the portion it stores to the server 1314. The server 1314 re-constructs the sensitive information in RAM in real-time and destroys it after sending the information to the settlement server 1315. This process protects against any SQL attacks or file system based attacks. It also limits the damage if a server 1314 or a mobile device is compromised.

The steps for adding a new funding account to a mobile device using the split-stored technique are summarized as follows. Similar steps can be easily extended to other types of sensitive information. The mobile device submits to a payment server the account type and the account information encrypted with the user's private key. The server performs a validation check, which may include a trial charge and duplication check. Then the server stores one portion of the sensitive account information. The sever sends back to the mobile device a globally unique account identifier for the new account. Then the mobile device stores the account identifier and the other portion (the second of two portions) of the sensitive account information.

There are many alternative ways to decide how sensitive information is split into two parts. For example, for a US credit card, the mobile device can store the first four digits and last four digits while the server stores the remaining digits in the middle of the number. A second method is that the mobile device decides how to split the information. A typical implementation of such a method would involve a second masking value when sending any sensitive information to the server. The masking value has the same bit length as the sensitive information, and a bit of the value of “1” indicates the corresponding bit in the sensitive data needs to be stored on the server. A third method is for the server to decide the splitting of sensitive data. In addition to the use of a masking value, the server could also use redaction. For example, if the mobile device sends a credit card number to the server, the server could send back the redacted credit card number where certain digits are changed to “X” corresponding to the portion of the sensitive data stored on the server. Further, the server can also use an encryption method to split the information. For example, the server can generate and store a random key, encrypt the account information using the key, and send the encrypted account information back to the mobile device. Thus, in this example of split storage, the encrypted text is stored by the mobile device and the encryption key is stored by the server.

The steps illustrated in FIG. 15 summarize the process using split-stored sensitive data in a payment transaction, in accordance with an embodiment. As illustrated in FIG. 15, certain steps are performed on the mobile device side 1501, and certain steps are performed on the payment server side 1514.

In step 1502, the mobile device 1501 reads a first part (of the two parts from the original split of data) of sensitive data from local storage. In step 1503, the mobile device 1501 sends the first part of the sensitive data along with other information in a message to the payment server 1514.

In step 1504, the payment server 1514 reads, extracts, or otherwise accesses the first part of the sensitive data from the received message from the mobile device 1501. In step 1505, the payment server 1514 reads the second part of the sensitive data from its own local storage. Then, in step 1506, the payment server 1514 combines the first and second parts of the sensitive data to reconstruct the complete, full version of the sensitive data. In step 1507, the payment server 1514 uses the reconstructed complete version sensitive data, for example, in communications with a settlement server 1315. After use, in step 1508, the payment server 1514 removes the full reconstructed version of the sensitive and the first part of the sensitive data from volatile storage. Accordingly, after step 1508, the payment server 1514 no longer has access to the first part of the sensitive data nor the complete sensitive data in any storage.

### 4.3 Secure Update of Profile Pictures

A third security enhancement to the payment system described with reference to FIGS. 13-14 is the presence of profile pictures that can be securely updated. As described above, in the transaction negotiation step 1401, the receiver 1302 will obtain information of the sender 1301. Such information may include a profile picture of the sender 1301. The receiver can verify the identity of the sender by looking at the profile picture and comparing it to the real person. Such a profile picture may initially be provided when a user account is created.

Some existing payment systems use user profile pictures to help verify the opposite party involved in a payment transaction. Some of these systems allow a user to change the picture easily at any time, which in essence makes having a profile picture lose much of its verification and security value. A hacker that hijacks a user account can easily replace it with his own picture. Some other systems make it very inconvenient, if not impossible, for a user to change such a profile picture.

While conventional systems either do not assure trustworthiness of new profile pictures or do not allow users to change their profile pictures, embodiments of the invention provide a secure mechanism for users to change their profile pictures.

In one implementation, any time a user desires a new profile picture, the picture is submitted back to the payment server 1314. The payment server 1314 performs an initial face comparison with the current profile picture and raises an alert if any anomaly is detected. Convention face matching algorithms can be used for the purposes of performing the initial face comparison.

Further, in some implementations, during an initial maturing period after a new profile picture is submitted, both the pervious picture and the new picture are presented during a transaction. (In one implementation, for a new user who has just registered the current profile picture, the previous picture is a standard blank picture.) During this maturing period, the opposite party will see both pictures instead of just the new one, and the opposite part will be alerted to the immaturity of the newer picture. After the maturing period, the previously mature picture will be phased out, and the newer picture will become mature. The newly matured profile picture will be the one displayed, and if applicable, the warning for its immaturity will be removed.

In one embodiment, if the user changes a profile picture again while the current profile picture is still immature, the latest picture will replace the current immature picture, instead of phasing out the previously mature picture. This will cause a reset to the beginning of the maturing period. This prevents a hacker from circumventing this security feature by rapidly replacing several profile pictures in succession.

In one embodiment, the maturity algorithm uses a combination of the amount of elapsed time and the number of transactions that have been successfully completed since the profile picture was submitted in order to calculate the maturity of the profile picture. The length of the elapsed time and the number of transactions are both positively correlated to maturity (i.e., the longer the time and the more transactions, the greater the maturity). The maturity of the profile picture is a signal of trust that the system has in the profile picture not being fraudulent. The system may advise a user to check photo identification of the other user if the other user's previous picture is blank or is significantly different from the current picture.

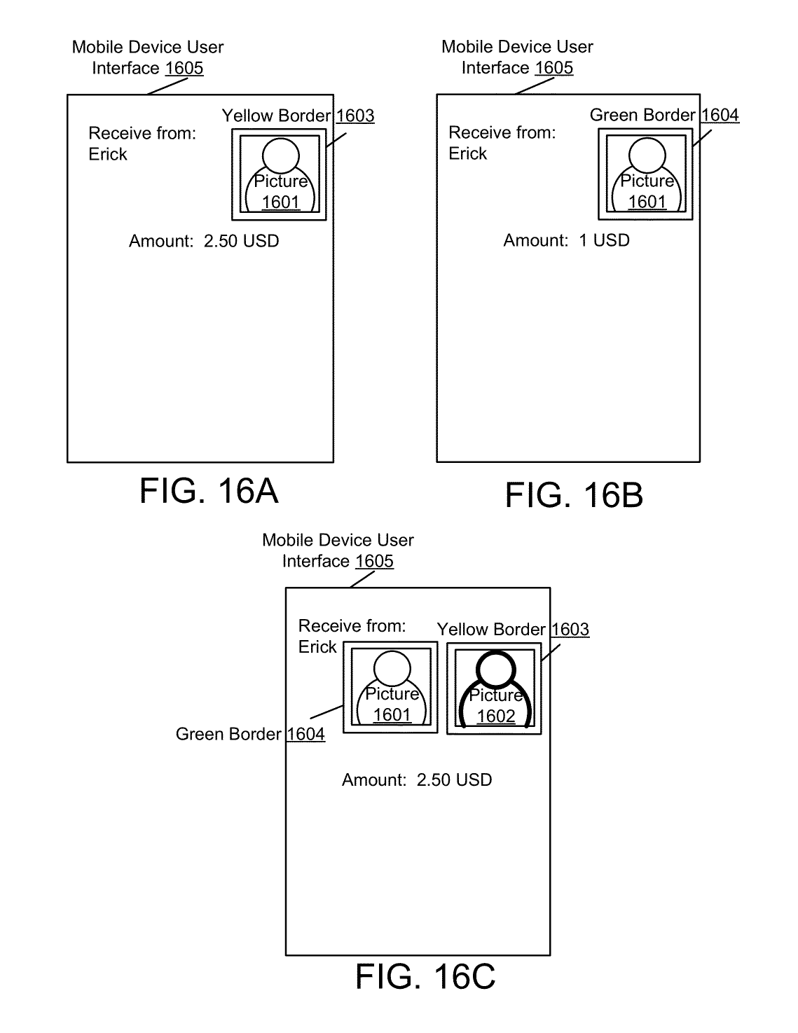

FIG. 16A is an illustration of an example user interface 1605 of a mobile device including an immature profile picture in accordance with an embodiment. When a user first creates an account, the profile picture 1601 the user provides is decorated with a yellow border 1603, or any other visually distinctive manner to denote the picture as immature. Only after some time elapses and a number of successful transactions have occurred with this profile will the profile picture 1601 be marked as mature. FIG. 16B is an illustration the profile picture 1601 of FIG. 16A, which has matured, in this example marked with a green border 1604 to indicate the maturity.

FIG. 16C is an illustration of another example user interface of a mobile device including both a mature old profile picture 1601 and an immature new profile picture 1602 in accordance with an embodiment. In this example, during the maturing period after a new profile picture 1602 has been submitted but before it becomes mature, both the previous picture 1601 and the new picture 1602 are presented during a transaction. The previous picture 1601 will not be removed until the new picture becomes mature.

### 5. Other Use Cases

### 5.1 Mobile Content Sharing

Smartphones contain a lot of useful content: contacts, music, video, photos, and applications. Mobile users like to share them with each other. The most popular methods of mobile content sharing include email or SMS, upload to a cloud server and then send the link to another user, and upload to some social network site and let other users discover. None of these methods are ideal when two phones are in proximity since the sharing is desired to be done instantaneously and in a manner that presents a more interactive and engaging user experience. Moreover, the sharing experience can be completed without false negatives and false positives that are present in other technologies.

A mobile content sharing system takes the peer-to-peer form (as in FIG. 6) where one of the mobile devices that intends to share content is the displayer 111 and the other mobile device that intends to receive the content is the scanner 112. (While the reversal of roles is possible, they are less intuitive in practical usage.) Further the base app 661 and a mobile content sharing applet 664 are installed on each device.

An example workflow includes the following steps. First, User A selects contents to be shared on mobile device A. After selection, a 2D barcode is generated and displayed on device A that includes the possible four logical components described earlier (RI 221, TkD 222, TkS 223, AppInfo 224). User B uses device B to scan the 2D barcode on device A. Using the information from the scanned barcode, device B establishes a secure and authenticated communication channel 666 with device A. Mobile content sharing applet on device A indicates it wishes to talk to mobile content sharing applet on device B. These two applets communicate over the secure and authenticated channel 666 to finish content transfer, and at the end tear down the channel. Device B receives the content, which is then available for user B to access from device B.

### 5.2 Mobile Loyalty Program

Customer loyalty programs are very important for merchants, especially small and medium sized business (SMB) owners. Consumers love them because they can save money on the things they would otherwise buy anyway.

Two basic functions of a loyalty program are accruing points and redeeming points. Advanced functions may include purchasing points, special (perhaps personalized) discounts, ads and promotions. Conventional solutions ranges from basic paper cards with stamps on it to various plastic cards encoded with some ID info. For consumers, having too many cards, carrying them everywhere, and managing them becomes a burden. For merchants, simple solutions, such as stamped paper cards, do not give them advanced features, while SMB owners cannot afford to roll out their own individual solutions due to the technological barriers of developing and maintaining such solutions.

A mobile loyalty system based on the inventions disclosed herein can solve the problems and meet the demands. Merchant installs a checkout device or upgrades the existing point of sale machines to run the mobile loyalty servlet 551. During consumer checkout, the checkout device displays a barcode. The checkout device is the displayer 111. The barcode includes the possible four logical components described earlier (RI 221, TkD 222, TkS 223, AppInfo 224). The consumer uses a mobile device to scan the barcode on the checkout device. The mobile device is the scanner 112. Using the information from the scanned barcode, the mobile device establishes a secure and authenticated communication channel 555 with the checkout device. A loyalty servlet 551 on the checkout device indicates it wishes to talk to the loyalty applet 554 on the mobile device. Depending on the configurations and settings of the loyalty program set up by the shop owner, through the UI of loyalty applet the consumer may accrue more loyalty points, redeem any loyalty points, purchase loyalty points (perhaps at a discount), receive special discounts (e.g., birthday special), receive coupons for future visits, participate in a survey, be prompted to participate in any other interaction with the loyalty servlet 551 that the shop owner may deem desirable.

This system can log various business information, such as customer demographics, customer habits and patterns, seasonal variations, marketing responses, etc. Such data can be aggregated and provided to business owners as further add-on services.

### 5.3 Web Login, Form Filling, Online Shopping, 2-Factor Authentication

People today have many username/passwords to remember, some of them are forced to change periodically. On top of that, people also have many credit cards. Managing all these passwords and credit card numbers has been a pain for many people. In addition, typing sensitive information such as username/passwords and credit card numbers on public computers is usually not safe.

Embodiments of the invention provide a solution for such problems: a user's smartphone is used to store such sensitive information, as well as some of user's personal information such as name and addresses. When the user needs to fill a form on a PC, a QR code is displayed alongside the form to fill. The user can use the base app 552 on his smartphone to scan the QR code, and the Applet 554 for form filling takes care of automatically using the user's sensitive and personal information stored on the user's smartphone to fill the form. In one embodiment, filling the form is one of the steps for online shopping.

In one embodiment, the form to fill is a form within a Web page, and the QR code is created by the Web server. In this embodiment, the Web server is the displayer 111. In another embodiment, such QR code is created by a trusted browser plug-in. In this case, the plug-in is the displayer 111. The plug-in optionally can verify the domain name of a webpage and encode such verified domain name into the QR code to mitigate phishing attacks.

Several variations of this use case example may be used to obtain further advantages, depending upon the situation. In one embodiment, the QR code is not displayed until a pointing device such as a mouse enters the form area, and the QR code is displayed as overlay on the page but it does not occlude the form. In one embodiment, the sensitive and personal information are directly sent to the server without going through the PC, so that viruses or malware on the PC are less of a concern. In one embodiment, the form still needs to be manually filled in addition to using a smartphone to scan the QR code and send username/password and other data from the smartphone. This is a case of 2-factor authentication where information from two different channels are used to authenticate the user.

### 5.4 TV Shopping

TV shopping program displays a QR code on screen. A viewer uses a smartphone which has base app 552 installed to scan the QR code. A communication channel with the Servlet 551 is established. The Servlet 551 may reside somewhere on the Internet.

An Add-on Applet 554 for the particular TV shopping program is installed (if is not installed already) and executed. The Applet 554 displays more information on the smartphone regarding the product advertised on TV, some of the information contains hyperlinks or other UI widgets for user interaction.

In one embodiment, the QR code contains time information, so that the content displayed by the Applet 554 is in sync with what is displayed on the TV, so that the user does not need to scan again when the product on TV changes. In one embodiment, the AppInfo part of the barcode contains promotional information, so that users that scanned the barcode get certain discounts. Optionally, a TkD 222 contained in the barcode can be used to authenticate the seller of the product, to reduce the risk of consumer fraud.

As a user purchases a product through the Applet of the TV shopping program, personal info stored on the device and accessible through the base app 552 can be retrieved to automatically fill fields of a shopping form, as discussed above.

### 5.5 Access Badge

In one use case, a smartphone is a scanner 112, which scans barcode displayed by door lock system (which is a displayer 111). The add-on applet 554 on the smartphone contacts the servlet 551 on the door lock system through established secure communication channel 555 to authenticate the owner of the smartphone, and unlock the door. In this use case, the servlet 551 can optionally be connected to the user account management system of the user's company.

In second use case, the smartphone is a displayer 111, which displays a barcode. The door lock system has a camera to scan the barcode, and has a base app 552 installed. An add-on applet within the base app 552 uses TkD 222 included in barcode, and optionally with help from another domain specific server such a certificate authority, to authenticate the device and unlock the door.

### 6. Additional Configuration Considerations

The disclosure herein has been described in particular detail with respect certain embodiments. Those of skill in the art will appreciate that other embodiments may be practiced. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments disclosed herein include process steps and instructions described herein in the form of an algorithm. It should be noted that the process steps and instructions could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages or protocols are provided for enablement and best mode of the present invention.

The embodiments disclosed herein are well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure herein is intended to be illustrative, but not limiting, of the scope of the invention.

What is claimed is:

1. A method of establishing communication between two computing devices in proximity, the method comprising displaying a barcode on a screen of a displayer device, the barcode including encoded routing information to enable a scanner device to communicate with the displayer device via a communication network.

2. The method of claim 1, wherein the barcode further comprises a security token for authenticating the displayer device.

3. The method of claim 1, wherein the barcode further comprises a security token for authenticating the scanner device.

4. A method of establishing communication between two computing devices in proximity, the method comprising:
scanning a barcode displayed on a screen of a displayer device, the barcode including encoded routing information to enable a scanner device to communicate with the displayer device via a communication network;
decoding the encoded routing information;
contacting the displayer device via the communication network using the decoded routing information; and
receiving subsequent communication from the displayer device via the communication network.

5. The method of claim 4, wherein the barcode further comprises a security token for authenticating the displayer device.

6. The method of claim 4, wherein the barcode further comprises a security token for authenticating the scanner device.

7. The method of claim 4, wherein the barcode further comprises information specific to an application, and the subsequent communication from the displayer device relates to the application.

8. A method of installing an add-on applet to a base application on a scanner device, the method comprising:
scanning a barcode with a base application on the scanner device;
identifying a target applet from information in the barcode;
downloading the target applet from a remote server if the target applet is not yet installed on the scanner device; and
installing the downloaded target applet in the base application on the scanner device.

9. The method of claim 8, wherein the base application has access to a user's personal data stored on the scanner device and the target applet can access the user's personal data from the base application.

10. A method comprising creating a visually branded 2D barcode, wherein the visually branded 2D barcode indicates a particular brand of scanning application to use to scan the barcode in order for the scanning application to properly decode information in the 2D barcode, wherein the information encoded in the 2D barcode comprises a standard part that is understood by generic scanning applications and a proprietary part that is only understood by the particular brand of scanning application.

11. The method of claim 10, wherein the properly decoded information includes routing information to enable a scanner device with the particular brand of scanning application that scans the 2D barcode to communicate with a device displaying the 2D barcode.

12. The method of claim 10, wherein the visually branded 2D barcode comprises a logo.

13. The method of claim 10, wherein the visually branded 2D barcode comprises colored pixels forming a distinctive visual pattern.

14. The method of claim 10, wherein the visually branded 2D barcode comprises a shape built in the surrounding area of the barcode.

15. A method of operating a payment server in a mobile payment system, the method comprising:
receiving a first submission from a sender of a payment, the submission responsive to a negotiation between the sender and a receiver for payment;
receiving a second submission from a receiver of a payment, the second submission responsive to the negotiation;
matching the first submission with the second submission; and
responsive to the first submission matching the second submission, processing the payment.

16. The method of claim 15, wherein processing the payment comprises communicating an execution order to a settlement server and receiving confirmation of the execution of the payment.

17. The method of claim 16, further comprising:
communicating the confirmation of the execution of the payment to the sender and the receiver.

18. A method of operating a payment server in a mobile payment system, wherein sensitive data has been split into two parts, a first part stored by the mobile device and the second part stored by the payment server, the method comprising:
accessing the first part of the two parts of sensitive data from a message received by the payment server from the mobile device;
accessing the second part of the two parts of sensitive data from storage;
combining the first and second parts of sensitive data to form a complete version of the sensitive data;
using the complete version of the sensitive data in an execution order to a settlement server; and
removing the complete version of the sensitive data and the first part of the sensitive data from volatile memory of the payment server.

19. A method of managing profile picture updates associated with a payment system, the method comprising:
during an immaturity period of a new profile picture, displaying the new profile picture with a first visual distinction to signal the immaturity; and
responsive to the profile picture maturing through at least one of a passage of a period of time and a completion of a number of transactions, displaying the new profile picture with a second visual distinction to signal the maturity of the profile picture.

20. The method of claim 19, wherein during an immaturity period of a new profile picture, a previously mature profile picture is presented along with the new profile picture during a transaction.
